(19) United States
(12) Patent Application Publication
(10) Pub. No.: US 2023/0258204 A1
(43) Pub. Date: Aug. 17, 2023

(54) Soft Variable Impedance Actuator Using Embedded Jamming Layer

(71) Applicant: The Board of Trustees of the Leland Stanford Junior University, Stanford, CA (US)

(72) Inventors: Brian H. Do, Plant City, FL (US); Inrak Choi, Seoul (KR); Sean Weston Follmer, Palo Alto, CA (US)

(21) Appl. No.: 18/109,432

(22) Filed: Feb. 14, 2023

Related U.S. Application Data
(60) Provisional application No. 63/310,642, filed on Feb. 16, 2022.

(51) Int. Cl. F15B 15/02; B25J 9/10

(52) U.S. Cl. CPC F15B 15/02; B25J 9/1075

(57) ABSTRACT

A variable impedance actuator is provided with a bladder-style actuator having a first end and a second end, and a jamming brake located inside the bladder-style actuator and connected to the first end and the second end of the bladder-style actuator. The bladder-style actuator and the jamming brake are independently controlled.

### CROSS-REFERENCE TO RELATED APPLICATIONS

This application claims priority from U.S. Provisional Patent Application 63/310,642 filed Feb. 16, 2022, which is incorporated herein by reference.

### STATEMENT OF GOVERNMENT SPONSORED SUPPORT

This invention was made with Government support under contract 1542152 awarded by the National Science Foundation. The Government has certain rights in the invention.

### FIELD OF THE INVENTION

This invention relates to actuators.

### BACKGROUND OF THE INVENTION

Variable impedance actuators can enable safer human-robot interaction. Soft actuators such as pneumatic artificial muscles (PAM), which are intrinsically safe due to their inherent compliance, can be used to produce variable impedance but often feature a number of downsides. The present invention addresses shortcomings in the art and provides a new type of actuator.

### SUMMARY OF THE INVENTION

In particular, the McKibben muscle, which is the most used PAM is unable to independently vary its stiffness and displacement, making it difficult to control, and features low damping, which can inadvertently result in stored energy during collisions and rebound. Researchers have tried to address the former through complex control strategies and the latter through using large brakes, such as magnetorheological or electrorheological brakes, in parallel with McKibben muscles. By incorporating a layer jamming brake inside of a PAM, in this case a McKibben muscle, we can produce an all-soft variable impedance actuator whose overall profile remains identical to a standalone PAM while enabling simpler control and braking/clutching abilities.

This soft actuator has a layer jamming brake enclosed inside of a pneumatic artificial muscle (PAM). This improves muscle and brake performance, such as providing improved dynamic response and enhanced bandwidth, while enabling new functionality, such as independent stiffness and position control in a single actuator.

The SJBAM can be used in all applications where McKibben muscles and other similar pneumatic actuators are currently in use, such as for industrial robots or other industrial machinery; exoskeletons; haptic interfaces.

The SJBAM enables positive pressure layer jamming and thus does not need a vacuum to jam. It also increases the bandwidth of jamming devices due to its ability to achieve super-atmospheric pressure differences.

### DETAILED DESCRIPTION

Other embodiments, further teachings and/or examples related to the invention are described in U.S. Provisional Patent Application 63/310,642 filed Feb. 16, 2022, which is incorporated herein by reference in its entirety.

What is claimed is:

1. A variable impedance actuator, comprising:
(a) a McKibben actuator having a first end and a second end; and
(b) A jamming brake located inside the McKibben actuator and connected to the first end and the second end of the McKibben actuator, wherein the McKibben actuator and the jamming brake are independently controlled.

2. A variable impedance actuator, comprising:
(a) a bladder-style actuator having a first end and a second end; and
(b) a jamming brake located inside the bladder-style actuator and connected to the first end and the second end of the bladder-style actuator, wherein the bladder-style actuator and the jamming brake are independently controlled.
